(19) United States
(12) Patent Application Publication
(10) Pub. No.: US 2024/0155457 A1
(43) Pub. Date: May 9, 2024

(54) Methods, Apparatuses and Systems for Use in a Handover in a Wireless Communication Network

(71) Applicant: Telefonaktiebolaget LM Ericsson (publ), Stockholm (SE)

(72) Inventors: Attila Báder, Paty (HU); László Kovács, Martonvásár (HU); Gábor Magyar, Dunaharaszti (HU)

(21) Appl. No.: 18/279,547

(22) PCT Filed: Apr. 30, 2021
(86) PCT No.: PCT/EP2021/061367

§ 371 Date: Aug. 30, 2023

(51) Int. Cl. H04W 36/36; H04W 36/00; H04W 36/30; H04W 36/32

(52) U.S. Cl. CPC H04W 36/362; H04W 36/00833; H04W 36/304; H04W 36/324

(57) ABSTRACT

Methods, apparatuses and systems performed and configured to operate in a wireless communication network are presented. In example implementations, the methods, apparatuses and systems are configured for use in a conditional handover for a user equipment in the wireless communication network. Based on a known first location of the user equipment in a first cell of the wireless communication network at a first point in time, a second location of the user equipment at a second point in time is predicted. The prediction is based on applying a movement prediction to the user equipment relative to the known first location at the first point in time. A probability for the second location to be located in at least one of the first cell and any one of one or more second cells in the wireless convocation network is thereby obtained. The one or more second cells are different from the first cell. Based on the obtained probability, it is determined for which one or more of the one or more second cells the conditional handover is to be configured.

### TECHNICAL FIELD

The present disclosure generally relates to methods, apparatuses and systems used in handovers in a wireless communication network. In particular, methods, apparatuses and systems according to example implementations as described herein allow for predicting a location of a user equipment based on which a conditional handover is configured.

### BACKGROUND

Services offered in a wireless communication network, and in particular in the 5th generation (5G) wireless communication network may require the network to have low-latency and high-reliability characteristics. This may apply, for example, to mission-critical and emergency services provided in the wireless communication network. These characteristics which the wireless communication network may need to entail may be particularly critical in relation to the radio (that is, radio communications), especially regarding mobility, i.e. in handover scenarios.

The 3^{rd} generation partnership project (3GPP) specified and introduced the “Conditional Handover (CHO)” functionality in Release 16 (Rel-16). Based on the CHO, mobility robustness may be improved. In particular, the CHO has allowed for reducing the failure rate for mobile user equipments (UEs) in handover scenarios, in which a UE moves from a cell in which it is served by a first base station to another cell where it is served by the first base station or a second base station.

In a CHO procedure, multiple candidate target cells, which may potentially serve the UE, are prepared in advance for handover. Therefore, unlike in the case of a normal handover procedure (in which a single cell is prepared for the handover), the preparation for cells in the CHO occurs before the UE experiences the handover. In this case, when radio conditions for reliable transmission of signals meet certain qualities, a handover command is sent to the UE in advance, as opposed to the legacy (normal) handover procedure in which the handover command is sent to the UE when radio conditions start to degrade.

In the CHO procedure, upon the UE receiving the handover command, the command is stored and applied only when the conditions configured in the UE are fulfilled for one of the configured candidate target cells. If this is the case, the UE executes the handover and connects to the target cell as in a normal handover procedure.

The risk of failure for a handover due to transmission of the measurement report and/or reception of the handover command not being transmitted or received without error is reduced, given that the handover command is sent when radio conditions still meet certain qualities. Since the handover procedure is also prepared in advance, the handover procedure execution time is reduced as well, such that the handling of situations in which a UE moves at moderate speeds (at which a fast and efficient legacy handover, that is a normal handover is challenging) is improved.

The interruption time is also reduced for a conditional handover even if a failure occurs, since handover commands have already been stored for a plurality of cells.

In order to determine whether service quality and network quality fulfil certain requirements, subscriber and network analytics systems are utilized. Such subscriber and network analytics systems are part of the network management domain and monitor and analyze service and network quality at session level in mobile networks. These analytics systems have been exploited in Network Operation Centers (NOC), and in Service Operation Centers (SOC) so that service quality is monitored and detected service quality issues can be troubleshot for extended periods of time. Subscriber and network analytics systems are also more and more used for automatic network operation.

Often, a key factor for telecommunication service providers and the network analytics systems is the quality of service that is experienced by a subscriber. It is therefore a crucial role to assure service quality when the telecommunication network is managed or when automatic network operation functions are performed. Such automatic network operation functions are often part of Network Data Analytics Function (NWDAF) or Management Data Analytics Functionality (MDAF) 3GPP standard functions.

In network analytics systems, basic network key performance indicators (KPIs) are continuously monitored, where the KPIs are based on node and network events and counters. Often, KPIs are aggregated in time, for example for node or other dimensions (for example in relation to a device type, a service provider, or other network dimensions, such as a cell, a network node, etc.). Failures of a node or the network can be indicated via the KPIs, but they may not be detailed enough in order for those failures to be troubleshot. Furthermore, in some cases, KPIs may not allow for identifying end-to-end, user-perceived service quality issues.

Elementary network events and end-to-end service quality metrics may be collected and correlated and user level end-to-end KPIs may be computed based on the available data using advanced analytics systems. These types of solutions may be suitable for session-based troubleshooting and analysis of network issues.

Real-time analytics may be exploited in order to provide for fast reaction in network management. This may require real-time collection and correlation of specific node and protocol events from different radio and core nodes, probing signaling interfaces and the user-plane traffic. Besides such data collection and correlation functions, which may handle a large amount of information, and analytics system may require advanced databases, a rule engine, and a big data analytics platform. The per subscriber service quality and network KPIs may be aggregated for different network dimensions.

### SUMMARY

In view of the foregoing, improvements may be required for conditional handovers, in particular in order to improve overall service quality for a UE in a wireless communication network while reducing signaling load for handover preparation.

Therefore, according to an aspect of the present disclosure, there is provided a method for use in a conditional handover for a user equipment in the wireless communication network. The method comprises predicting, based on a known first location of the user equipment in a first cell of the wireless communication network at a first point in time, a second location of the user equipment at a second point in time. The prediction is based on applying a movement prediction to the user equipment relative to the known first location at the first point in time. A probability for the second location to be located at the second point in time in at least one of the first cell and any one of one or more second cells in the wireless convocation network is thereby obtained. The one or more second cells are different from the first cell. The method further comprises determining, based on the obtained probability, for which one or more of the one or more second cells the conditional handover is to be configured.

It is hereby to be noted that the term “movement” as used throughout the present disclosure (for example in relation to movement prediction) may be exchanged with the term “mobility” as used throughout the present disclosure (for example in relation to mobility prediction). Generally, the prediction relates to the user equipment being located at a particular location and/or in a particular cell in the wireless communication network at a future (second) point in time. “Movement” and “mobility” may be used interchangeably throughout the present disclosure.

One of the one or more second cells may be served by the same base station that serves the first cell or it may be served by a second base station which is different from the first base station. As will be appreciated, obtaining the probability for the second location to be located in at least one of the first cell and any one of the one or more second cells may, in some examples, refer to there being a probability larger than zero of the second location being located in the first cell and/or a probability larger than zero of the second location being located in a first one of the second cells and/or a probability larger than zero of the second location being located in a second one of the second cells. As will be appreciated, the probability may also be larger than zero for three or more of the second cells (in some examples in addition to the probability being larger than zero for the second location being located in the first cell).

Applying the movement prediction may, in some examples, relate to applying a movement prediction model to the user equipment being at the first location at the first point in time to predict the second location, whereby the movement prediction model has previously been obtained.

In some examples, applying the movement prediction to the user equipment in order to obtain the probability is based at least in part on a speed of movement of the user equipment at the first point in time and/or on a direction of movement of the user equipment at the first point in time.

Furthermore, in some examples, the method further comprises determining whether there is a difference in service quality (experienced by the user equipment) between the conditional handover and a non-conditional (i.e. a normal/legacy) handover. The conditional handover comprises configuring a plurality of the second cells for the conditional handover. The non-conditional handover comprises configuring a single one of the second cells for the non-conditional handover.

In some examples, if it is determined that there is a difference in service quality between the conditional handover and the non-conditional handover, a predefined number of the second cells is configured for the conditional handover. In particular, the predefined number of the second cells may be less than a total number of cells neighboring the first cell.

In some examples, if it is determined that there is no difference in service quality, only a single one of the second cells is configured for the non-conditional handover.

In some examples, the conditional handover is configured for two of the second cells which have the two highest probabilities for the second location to be located in the respective one of the two cells amongst the second cells.

In some examples, the conditional handover is configured only for those of the second cells for which the probability is above a predefined threshold probability (higher than zero, and, for example, 10%, 20%, 30%, or 40%. As will be appreciated, other threshold probabilities may be defined).

In some examples, the conditional handover is configured for one or more of the second cells only when a service used by the user equipment at the first point in time has been predefined to be a handover-sensitive service. Such a handover-sensitive service may, in some examples, comprise one or more of ultra-low latency traffic, real-time video and voice service. Additionally or alternatively, in some examples, the non-conditional handover is configured when a service used by the user equipment at the first point in time has been predefined to be a handover-non-sensitive service. Such a handover-non-sensitive service may, in some examples, comprise one or both of a data file download and web (internet) browsing.

In some examples, the application of the movement prediction comprises applying a movement prediction model to the user equipment. The method further comprises, in this example, training the movement prediction model based on a user identity relative to the user equipment, a first timestamp, T1, a first position of the user equipment at T1, a second timestamp, T2, and a second position of the user equipment at T2.

In some examples, the training of the movement prediction model is further based on information relative to a service used by the user equipment at T1.

In some examples, the method further comprises determining an accuracy of the movement prediction model by comparing (i) a predicted position of the user equipment at T2, wherein the prediction is based on applying the movement prediction model to the user equipment being at the first position at T1, with (ii) the second position.

In some examples, the second location is predicted after one or more of the following conditions have been fulfilled: the training has been performed for at least to a predefined time period, and an amount of input feature samples for the training is above a predefined threshold amount.

In some examples, the second location is predicted after the accuracy is above a predefined threshold accuracy.

In some examples, the method according to example implementations as described herein may be used in a conditional handover for a plurality of user equipments. The training of the movement prediction model is then performed, in some examples, for no more than a fraction n % of the plurality of user equipments simultaneously, wherein n<100, and wherein the training is repeated 100/n times to cover each of the plurality of user equipments. In some examples, the user equipments of the fraction are randomly chosen for each training performance.

In some examples, a frequency for the determining for which of the one or more second cells the conditional handover is to be configured is dependent on a moving speed of the user equipment. For example, the lower the moving speed, the lower the number of second cells for which the conditional handover may be configured.

In some examples, the second location is predicted continuously. The determining for which of the one or more second cells the conditional handover is to be configured is performed at one or more predefined times in a time window starting with the first point in time and ending with the second point in time.

In some examples, a number of cells for which the probability is predicted is chosen so that a summed probability for the second location to be located in any one of said number of cells is higher than a predefined probability threshold. In some examples, the predefined probability threshold is 90% (although other values may be chosen).

In some examples, the method further comprises configuring the conditional handover for those one or more cells of the one or more second cells which neighbor the first cell. Non-neighbor cells may thus, in some examples, be excluded from being prepared for a conditional handover.

In some examples, the determining for which of the one or more second cells the conditional handover is to be configured is further based on one or more of: a neighbor cell relation between the first cell and a corresponding, respective one of the one or more second cells, a handover success rate and/or handover failure rate for a said neighbor cell relation, a service quality degradation during handover for a said neighbor cell relation and/or for one or more service types, a service quality per cell and/or per said neighbor cell relation and/or per service, and a radio condition per cell and/or per said cell neighbor relation.

According to a further aspect of the present disclosure, there is provided a method performed by a network management analytics module or apparatus in a wireless communication network. The method comprises receiving, from a first base station, a request for a conditional handover decision. The request comprises information regarding a user equipment identification of a user equipment and a first location of the user equipment in a first cell in the wireless communication network at a first point in time, wherein the first cell is served by the first base station. The method further comprises fetching one or more second cells of the wireless communication network, wherein the one or more second cells are different from the first cell. The method further comprises predicting, based on the first location of the user equipment in the first cell at the first point in time, a second location of the user equipment at a second point in time by applying a movement prediction to the user equipment relative to the first location at the first point in time to obtain a probability for the second location to be located in at least one of the first cell and any one of the one or more second cells. Furthermore, the method comprises determining, based on the obtained probability, for which one or more of the one or more second cells the conditional handover is to be configured. The method further comprises sending, to at least one of the first base station and one or more second base stations, a message comprising information relative to the one or more second cells for which it is determined that the conditional handover is to be configured. One of the one or more second cells is served by at least one of the first base station and one or more second base stations which are different from the first base station. The prediction of the second location may preferably be performed according to any of the example implementations as described throughout the present disclosure.

According to a further aspect of the present disclosure, there is provided a method performed by a first base station serving a first cell in a wireless communication network. The method comprises sending, to a network management analytics module or apparatus, a request for a conditional handover decision. The request comprises information regarding a user equipment identification of a user equipment and a first location of the user equipment in the first cell at a first point in time. The method further comprises receiving, from the network management analytics module or apparatus, a message comprising information relative to one or more second cells for which it is determined that the conditional handover is to be configured. One of the one or more second cells is served by at least one of the first base station and one or more second base stations which are different from the first base station. The information relative to the one or more second cells is based on a probability of the user equipment being located at a second location at a second point in time. The second location is in at least one of the first cell and any one of the one or more second cells. The probability is obtained based on a user equipment movement prediction based on the information regarding the first location of the user equipment in the first cell at the first point in time. The prediction of the second location may preferably be performed according to any of the example implementations as described throughout the present disclosure.

There is further described a computer program product comprising program code portions that, when executed on at least one processor, configure the processor to perform the method according to any of the examples as described throughout the present disclosure. In some examples, the computer program product is stored on a computer-readable recording medium or encoded in a data signal.

According to a further aspect of the present disclosure, there is provided an apparatus adapted to operate in a wireless communication network for at least partially controlling a conditional handover for a user equipment. Controlling the conditional handover at least partially may, in some examples, refer to the apparatus being adapted to influence a conditional handover decision and/or conditional handover preparation, or it may refer to the apparatus also receiving information from another network entity to control the conditional handover. The apparatus is configured to predict, based on a known first location of the user equipment in a first cell of the wireless communication network at a first point in time, a second location of the user equipment at a second point in time by applying a movement prediction to the user equipment relative to the known first location at the first point in time. A probability for the second location to be located in at least one of the first cell and any one of one or more second cells in the wireless communication network is thereby obtained, wherein the one or more second cells are different from the first cell. The apparatus is further configured to determine, based on the obtained probability, for which one or more of the one or more second cells the conditional handover is to be configured. Preferably, the apparatus is adapted to perform any of the preferred examples outlined throughout the present disclosure.

According to a further aspect of the present disclosure, there is provided a first base station adapted to serve a first cell of a wireless communication network. The first base station is configured to send, to a network management analytics module or apparatus comprised in the wireless communication network, a request for a conditional handover decision. The request comprises information regarding a user equipment identification of a user equipment and a first location of the user equipment in the first cell at a first point in time. The first base station is further configured to receive, from the network management analytics module or apparatus, a message comprising information relative to one or more second cells for which it is determined that the conditional handover is to be configured. One of the one or more second cells is served by at least one of the first base station and one or more second base stations different from the first base station. The information relative to the one or more second cells is based on a probability of the user equipment being located at a second location at a second point in time. The second location is in at least one of the first cell and any one of the one or more second cells. The probability is obtained based on a user equipment movement prediction based on the information regarding the first location of the user equipment in the first cell at the first point in time. Preferably, the first base station is adapted to perform any of the preferred examples outlined throughout the present disclosure.

There is further described a system comprising the apparatus according to any of the examples described throughout the present disclosure, and the first base station according to any of the example implementations as described throughout the present disclosure.

### BRIEF DESCRIPTION OF THE DRAWINGS

Further aspects, details and advantages of the present disclosure will become apparent from the detailed description of exemplary embodiments below and from the drawings, wherein:

FIGS. 1a and b show schematic illustrations of a network architecture and parts thereof according to example implementations of the present disclosure;

FIG. 2 shows a schematic illustration of a network management analytics system according to example implementations of the present disclosure;

FIG. 3 shows a flow diagram of service quality statistics collection according to example implementations of the present disclosure;

FIG. 4 shows a flow diagram of mobility prediction model training according to example implementations of the present disclosure;

FIG. 5 shows a flow diagram of conditional handover optimization according to example implementations of the present disclosure;

FIG. 6 shows a schematic block diagram of an apparatus according to example implementations of the present disclosure;

FIG. 7 shows a schematic block diagram of any one or more of the base stations according to example implementations of the present disclosure;

FIG. 8 shows a schematic block diagram of a system according to example implementations of the present disclosure;

FIG. 9 shows a flow diagram of a method according to example implementations of the present disclosure;

FIG. 10 shows a flow diagram of a further method according to example implementations of the present disclosure;

FIG. 11 shows a flow diagram of a further method according to example implementations of the present disclosure; and

FIG. 12 shows a schematic block diagram of a wireless communication network according to example implementations of the present disclosure.

### DETAILED DESCRIPTION

The present disclosure relates in particular to an analytics system for personalized conditional handovers in, for example, 5G.

In the following description, for purposes of explanation and not limitation, specific details are set forth in order to provide a thorough understanding of the present disclosure. It will be apparent to one of skill in the art that the present disclosure may be practiced in other embodiments that depart from these specific details.

While, for example, the following description focuses on an exemplary network configuration in accordance with 5G specifications, the present disclosure is not limited in this regard. The present disclosure could, for example, also be implemented in other cellular or non-cellular wireless communication networks, such as those complying with 4th generation (4G) specifications (e.g., in accordance with the Long Term Evolution (LTE) specifications as standardized by the 3 rd Generation Partnership Project (3GPP)).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by the one or more processors.

In the following description of exemplary implementations, the same reference numerals denote the same or similar components.

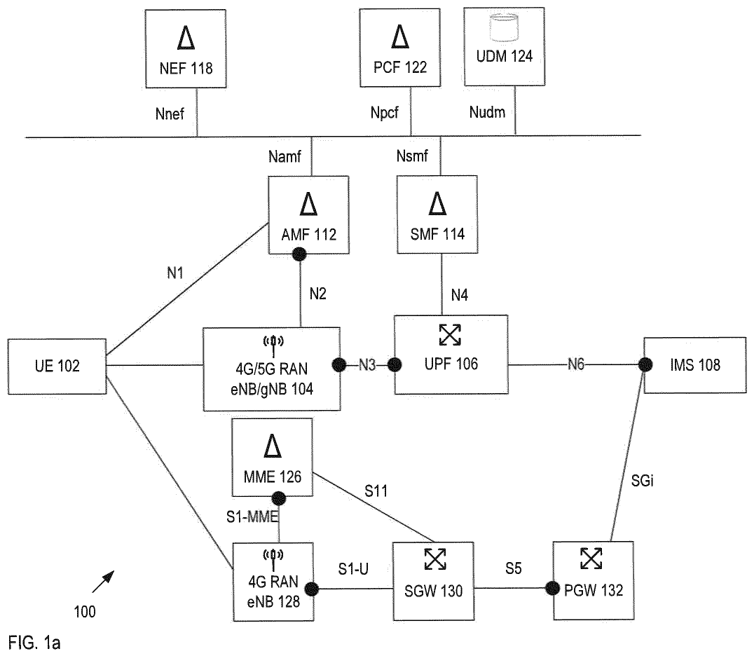

FIG. 1a illustrates a block diagram of a wireless communication network 100 according to examples described herein. In this example, the 5G network architecture may relate to a non-roaming architecture.

A portion of the 5G reference architecture is defined by 3GPP (see, e.g., 3GPP TS 23.501 V16.3.0). Some architectural core network entities (network functions, NFs) and core network interfaces for examples of the present disclosure may include:
1) A User Equipment (UE) 102 as an exemplary terminal device. The UE 102 constitutes, for example, an endpoint of a voice-over-IP call or of a video or audio streaming session that stretches via the access network domain (AND), such as via a (radio) access network ((R)AN). In this example, the RAN is a 4G/5G RAN eNB/gNB 104.
2) In some examples, an Application Function (AF) (not shown) may be located outside the core network domain (CND) and typically implemented as, or on, an application server operated by a dedicated service provisioning entity (e.g., an Over-the-top (OTT) entity). The AF is configured to interact with the CND via an Naf interface. In some examples, the AF may provide voice-over-IP, video streaming or audio streaming services.
3) A Network Exposure Function (NEF) 118 has an Nnef interface and supports different functionalities. Specifically, in the context of some examples, the NEF 118 may act as an entry point into the CND for the AF. The AF thus interacts with the CND through the NEF 118.
4) A Session Management Function (SMF) 114 has N4 and Nsmf interfaces. The SMF 114 supports procedures such as session establishment, modification and release as well as policy-related functionalities. In particular, the SMF 114 configures User Plane Function (UPF) 106 (for example for event reporting). Moreover, in some examples, the SMF 114 configures the UPF 106 accordingly through the N4 interface using the Packet Forwarding Control Protocol (PFCP).
5) The User Plane Function (UPF) 106 has an N4 interface to the SMF 114 and an N3 interface to 4G/5G RAN eNB/gNB 104. The UPF 106 supports handling of user plane traffic on the user plane based on the rules received from the SMF 114. In particular, in examples, the UPF 106 thus supports packet inspection and different enforcement actions (such as, for example, event detection and reporting).
6) The Policy Control Function (PCF) 122 supports, via an Npcf interface, a unified policy framework to govern the core network domain behavior. Specifically, the PCF 122 provides Policy and Charging Control (PCC) rules to SMF 114 and/or UPF 106 to, e.g., detect service traffic and enforce policy and charging decisions according to the PCC rules.
7) A unified data management (UDM) entity 124 centrally stores data (e.g., subscriber information) in the core network domain.
8) An access and mobility management function (AMF) 112 handles access and mobility for the UE 102. The AMF 112 is coupled to the UE 102 via an N1 interface. Furthermore, the AMF 112 is coupled to the 4G/5G RAN eNB/gNB 104 via an N2 interface.
9) A Network Repository Function (NRF) (not shown) may be provided in the wireless communication network 100. The NRF supports in particular the following functionality:
   The NRF supports the service discovery function. The NRF may receive an NF Discovery Request from an NF instance, and may provide the information of the discovered NF instances.
   Furthermore, the NRF may maintain the NF profile of available NF instances and their supported services.
10) A Network Slice Selection Function (NSSF) (not shown) may support selecting the set of network slice instances serving the UE 102. Furthermore, the NSSF may determine an AMF 112 set to be used to serve the UE 102, or, based on configuration, a list of candidate AMF(s), possibly by querying the NRF.
11) An Authentication Server Function (AUSF) (not shown) may support authentication for 3GPP access and untrusted non-3GPP access as specified in, e.g., 3GPP TS 33.501. It may further support network slice-specific authentication and authorization as specified in, e.g., 3GPP TS 23.502.
12) The Internet Protocol Multimedia Subsystem (IMS) 108 is coupled to the UPF 106 via interface N6. The IMS 108 aims at providing a standardized access to services from different networks.
13) In this example, the UE 102 is coupled to 4G RAN eNB 128.
14) A Mobility Management Entity (MME) 126 which manages UE 102 access network and mobility is coupled to the 4G RAN eNB 128 via an S1-MME interface.
15) A Serving Gateway (SGW) 130, which routes and forwards user data packets, while also acting as the mobility anchor for the user plane during inter-eNodeB handovers and as the anchor for mobility between LTE and other 3GPP technologies, is coupled to the MME 126 via an S11 interface and to the 4G RAN eNB 128 via an S1-U interface.
16) A Packet Data Network Gateway (PGW) 132, which provides connectivity from the User Equipment (UE) to external packet data networks (PDNs) by being its point of exit and entry of traffic, is coupled to the SGW 130 via an S5 interface and to the IMS 108 via an SGi interface.

Further functionalities and couplings between the entities comprised in the wireless communication network 100 can be found, e.g., in TS 23.501 V16.3.0.

Circles in FIG. 1a indicate event capturing points for the analytics system in some examples according to the present disclosure.

Examples of the present disclosure with their functionalities are implemented, in this example, in the analytics system 152 comprised in the network management 150, as shown in FIG. 1b. The analytics system 152 may be configured for analysis as part of a (conditional) handover procedure.

The network management 150 further comprises, in this example, a configuration management 154 adapted to configure a cell for a (conditional) handover, a fault management 156 for managing a fault in a handover procedure, and a performance management 158 which may be configured to manage the network performance during, e.g., a handover procedure.

In order to improve mobility/movement robustness, 3GPP specified and introduced a conditional handover (CHO) functionality in Release 16. It aims at reducing the failure ratio/rate for mobile UEs especially in handover situations. This may help to ensure strict requirements of new low-latency and high reliability 5G services.

It has been realized by the inventors that when a conditional handover is to be configured, multiple cells may need to be prepared for the conditional handover. Therefore, a set of resources may then need to be reserved while the UE monitors the handover condition and, as a result, the handover may not be performed. The conditional handover may further increase the number of required signaling messages, which may result in a large amount of signaling in particular in the case of dense areas with high load scenarios.

As a result, the network may need to carefully select target candidates amongst the cells and keep the number of target candidate cells to a reasonable amount. No smart algorithm has thus far been provided for selecting the optimal set of possible target cells.

Furthermore, by default, the radio subsystem where the CHO occurs does not have detailed information of the actually used service types per subscriber. Service requirements may therefore only be taken into account in a limited way (for example for a quality of service (QoS) bearer).

Cell selection algorithms of the state of the art for conditional handover have not considered the user mobility/movement and the expected trajectory of the end-user. Therefore, in conditional handover procedures of the state of the art, all candidate neighbor cells should be prepared for the handover, which may require unnecessary signaling load and processing capacity in radio nodes.

It is further to be considered that, usually, not all candidate target cells may provide the same quality for a given service. Some cells may perform a better service than others in case of service A, while others may perform a better service for service B. Additionally, some services provided may not have strict conditions on reliability (such as, for example, chat services). Therefore, if a subscriber only uses these kind of services, a conditional handover may not be needed. No solutions to date have considered the service used by the end-user and the service quality metrics of the candidate cells in a handover procedure, so that solutions according to the state of the art may lead to suboptimal cell selection for certain kinds of services.

Example implementations according to the present disclosure provide in particular a CHO optimization module. The CHO optimization module may optimize the CHO operation in which the user mobility/movement and the expected trajectory of the end-user, and, in examples, the used service and cell level service quality statistics are taken into account.

As will be further outlined below, the CHO optimization module may be part of the network management analytics system. In particular, the analytics system may collect personal subscriber correlated data from a user, signaling plane and radio nodes. In some examples, the correlated records include one or more of the used service, service quality, radio environment, location and handover, session setup, change and termination events.

A handover evaluation module may collect service quality statistics per services per neighbor cells for CHO which may be used or not used. A mobility (movement) prediction module may estimate the speed and the next cells for mobile subscribers with probability information.

Based on the mobility prediction (speed and next cell) and the expected service quality, the CHO may be configured, for example, not for all neighboring cells, but only for a smaller number of cells based on a certain logic. For example, if there is no service quality difference between CHO and HO for services or neighbor cells, CHO may not be configured. If the service quality is better for CHO for the neighbor cells, CHO is configured, for example, for a maximum of 2 to 3 neighbor cells. In some examples, the most probable neighbor cell and the subsequent most probable neighbor cell(s) may be configured as a backup. As a result, in some examples, during operation, CHO may be configured only for services where CHO improves the service quality and it is configured to a maximum of a few neighbor cells. Signaling traffic and node B resources may therefore be considerably reduced. Additionally, any service quality degradation due to CHO may be prevented. It may further be differentiated between services which are typically sensitive to handover, such as ultra-low latency traffic, real-time video or voice, and services which are typically not sensitive to handover, such as file downloading or web (internet) browsing.

Advantages of example implementations according to the present disclosure may in particular appear at the network level. CHO may be considered as an advantageous but expensive function from the point of view of network resources since many cells may need to be prepared during operation. Cell selection and preparation of the cells for conditional handover may occur well before the UE enters to a handover situation. Therefore, extra signaling during a handover situation may not be required.

Based on the consideration of the possible trajectory of the moving UE, CHO may be used not for all neighbor cells but only for the few most probable candidate cells. Network resources may therefore be saved significantly based on this operation.

Furthermore, since service quality may be continuously monitored per UE, CHO may not be used, in some examples, at all for sessions and neighbor cell relations in which service quality is not affected.

Reliability and good service quality are ensured in the solution according to example implementations according to the present disclosure which take the above aspects into account during target candidate cell selection.

In some examples of the present disclosure, a mobility prediction model may be applied in order to predict a location of the user equipment in the future.

One key enabler for example implementations of the present disclosure may be to have a subsystem within the network analytics system which may be able to predict the set of next visited location(s) in the next predefined time window for each subscriber with good accuracy.

It has been shown that human mobility/movement patterns are not random at all (see, e.g., 1. M. C. GONZÁLEZ, C. A. HIDALGO, A.-L. BARABÁSI: Understanding individual human mobility patterns. Nature 453, 779-782 (2008)), but individuals may follow certain trajectories more often than others. This may occur, in particular, when travelling from home to work, visiting parents, in shopping malls, etc.

As human mobility/movement patterns are not random, they can be learnt per individual and the learnt patterns may be used for predicting the next location or locations with good accuracy (see, e.g., Theodoros Anagnostopoulos, Christos Anagnostopoulos, Stathes Hadjiefthymiades: Mobility Prediction Based on Machine Learning, 12th IEEE International Conference on Mobile Data Management, 2011).

Such systems for predicting the next location or locations often, in their first training phase, may use a training dataset to derive an initial machine learning model for prediction. The machine learning model may, in some examples, be tested continuously for accuracy.

In some examples, when a sufficient amount of training data has been collected and built into the model, so that the accuracy may have reached a desired high level, the system may be capable of predicting the next location or locations for each individual and may then go operational. This operational phase may be dubbed the prediction phase.

In the prediction phase, the model may also, in some examples, be updated continuously, if necessary. Accuracy can, in some examples, also be continuously monitored for the past predictions, which may provide a self-evaluation.

In the present prediction phase, the system may offer a prediction function, which may be called with a given input data and by utilizing the learnt mobility patterns embedded in the model, the prediction function may output the set of possible next location(s) for the given individual with computed probabilities.

In the training phase, data may be collected from the mobile network in order to form training data samples for training the mobility/movement prediction model. In some examples, the data collection may be performed via the analytics system, in particular using a passive monitoring technique. The set of input features determines the kind of data which may need to be collected.

In some examples, the input features in the mobility prediction model comprise (but may, in some examples, not be limited to) the following information elements:
User identity (for example IMSI),
Unix Timestamp T1 (e.g. epoch, seconds since a certain date, e.g. 1 Jan. 1970); from the timestamp T1, the hour of day, day of the week, week of the year, weekend/weekday flag as time-specific input features may be derived),
Actual cellular position of the user (cell ID) at time T1,
Optionally, if a user is active at T1, service usage detailed information for the user at time T1 may be taken into account. Such information may, for example, include the type of activity, and further details, for example the service provider and/or service quality,
Unix Timestamp T2 (e.g. epoch, seconds since a certain date, e.g. 1 Jan. 1970); from the timestamp T2, the hour of day, day of the week, week of the year, weekend/weekday flag as time-specific input features may be derived),
Actual cellular position of the user (cell ID) at time T2.

The actual values of these input features may form a 6-tuple, which may be dubbed a training data sample. The structure of the training data sample, which may be the input data for training the mobility/movement prediction model, may be as follows:
(user-id, t1, position1, service-info, t2, position2)

One or more approaches may, in some examples, be taken in order to control the frequency of training data sample generation.

In a first approach, if the location of the user has not changed between T1 and T2, a training data sample may be generated periodically. T2 may be chosen to be T1+t, where t is a predefined parameter, such as, but not limited to t=300 (e.g. seconds). Samples in this case may be generated every five minutes.

In a second approach, if a successful handover occurs in the network for the user, a training data sample may be generated immediately. T1 may then denote the last registered time when the user was in the previous cell. T2 may denote the current time when the user is in the new cell.

During the training phase, the system may further try to predict the next location or locations for each user. The accuracy level may therefore be checked continuously. This may, in some examples, be performed based on a prediction and testing if the next different location of the given user (whenever a location change happens in the future) matches the predicted one or not, which may, in some examples, be performed for all users.

The system may enter the operational phase when a certain condition has been met. The condition may comprise one or more of the accuracy level having reached a predefined quality level, the training having been performed for a predefined amount of time, and upon another condition or conditions, for example when the amount of input features samples used for training has reached a predefined threshold.

The footprint of the training phase may further be optimized. It may not be necessary to track all the user equipments simultaneously when building the mobility/movement models. This is because a large amount of data may be collected and processed at once, which may result in a large footprint.

The model learning may be performed in an efficient way with low footprint. In some examples, instead of training the model for all user equipments at the same time, it may be done for a smaller number (for example n=5%) of all user equipments at once. The training may then be repeated 100/n times to cover every user equipment. While this may have a larger lead-time, it has a smaller footprint.

Furthermore, the training may be enhanced, for example, based on a learning every day for 100/n segments of user equipments, and it may be randomized which n % of the user equipments fall to which segment of the day. This may be repeated for a certain number of days to cover the time-dependent characteristics of the mobility/movement patterns.

In operation during the prediction phase, the prediction function is utilized in order to predict the next location or locations for each user. The input for the prediction function may, in some examples, be the first four data elements of the training data sample, in addition to a time window parameter delta (for example measured in seconds), marking the time window t1+delta for which the prediction is acquired. The structure of the input parameters for applying the mobility/movement prediction function may be as follows:
(user-id, t1, position1, service-info, delta)

Delta may be a system parameter, depending on how frequently the conditional handover setting for the users need to be updated. In some examples, delta may range from, for example, one minute to five minutes.

Delta may also depend on the user himself or herself. In some examples, for moving users, delta is kept lower as their location changes frequently, so that more frequent handover optimization may be necessary.

The above input for the prediction function may be collected by the analytics system for each subscriber, and in some examples continuously. The prediction function may be triggered regularly within a given time window.

The output of the prediction function may have the following structure:
(user-id, t1, delta, [position1, probability1, . . . , position_k, probability_k])

As can be seen, in this example, the output of the prediction function contains the same user-id that was applied as input, t1, and delta time parameters, as well as an output vector of length k which contains <position, probability> tuples. The latter predict the next possible locations for the user within time t1 and t1+delta. The length of the vector (k) is, in some examples, small, for example k≤3. The value of k may depend on the user behavior. In some examples, all possible locations may need to be predicted so that the sum of these probabilities is (close to) 100%, but in some examples over a threshold, for example over 90%. This cumulative probability reaching the threshold may vary per individual and situation. For example, a typically stationary user may have a vector with length k=1, etc.

An up-to-date predicted location set database with probabilities for each location may be available for each subscriber by applying the prediction function continuously for all subscribers in the mobile network.

The predicted location set database may be utilized by the conditional handover optimization module of the analytics system in order to achieve certain goals of the disclosure, namely, in some examples, to prepare less possible neighbor cells for conditional handover than the default number, to thereby avoid a significant amount of signaling traffic and thus save overall network resources.

In some examples, if the predicted cell is not a neighbor, it may be excluded since a mobile user can only be prepared for conditional handover for neighboring cells.

In some examples, the signaling gain may be as follows. The signaling gain may come from three factors: 1) The used service is taken into consideration. If the service is not typically affected by any handover problems, the CHO mechanism is completely switched off. 2) The predicted service quality in the neighboring (probably visited cell[s]) is also considered. If it is not critical, the CHO is also completely switched off. 3) Finally, if CHO is applied, based on the learnt mobility/movement patterns for the individual, instead of preparing the CHO for, e.g., 8 possible neighbors (which is a typical value), only, e.g., 2-3 neighbors are prepared. These three mechanisms together may ensure a high signaling reduction compared to the original CHO signaling without the optimization.

High-level estimate can be given for the CHO signaling gain: a service factor can imply that only 20% of services need the CHO at all (a gain factor of 5). Then, for these services, the neighbor cell based gain may be a factor of 3 (instead of, e.g., 8-9 cells use only, e.g., 2-3). These two factors together imply a gain factor of 15, so instead of 100% CHO signaling, only 1/15 of 100%<7%. Therefore, the 80-90% gain may be a conservative estimate in this example.

Examples for mobility/movement prediction may take into account, for example, the main paths when commuting to work, whether there is a weekend/weekday difference, and/or the time of the day may be taken into account.

When a user commutes, e.g., to work, delta in this period may be kept low, e.g. 1 minute (60 seconds). The system at a given point in time, T, say a Wednesday morning 8 AM, at a given cell, which has a traffic intersection, with several possible paths, may predict two next location entries (k=2), which both point towards the workplace, and in the past were used, one in case of a traffic jam rarely, e.g. with getting a probability of 5%, the other as the main path in most cases, getting a probability of 95%.

Imagining the same user as above, at the same time 8 AM, but on a weekend, being in the same intersection. Now the prediction may be different, not in relation to positions towards a workplace, but, e.g., to shopping malls.

Furthermore, imagining the same user, at the same position, but at 5 PM on a weekday. Now the position prediction may point towards cells in the direction of the home of the user.

Historical statistics data may also be incorporated in example implementations according to the present disclosure. Hereby, the analytics system may receive per UE event data from the core network function and radio nodes in real-time. The per flow correlated records may be aggregated for radio cells and for neighbor cell pairs taking into account the HO direction and for larger time scales (for example, 1 hour, 1 day, 1 week) and in order to obtain the following key performance indicators (KPIs):
Neighbor cell relations (including both conditional and non-conditional HOs),
Handover success/failure rate per neighbor cell relations,
Service quality degradation during handover per neighbor cell relations and per service types

The last two statistics may, in some examples, be obtained separately for conditional HO used or not used. These parameters may be used at decision making if conditional HO is beneficial or not. If these parameters are better for CHO than for HO, the probability to perform CHO to these cells will be higher.

Furthermore,
service quality per cell, per cell neighbor relations and per services and
radio conditions per cell and per cell neighbor relations (e.g. RSRP, RSRQ, CQI)

may be optional parameters which may be taken into account in decision making in order to improve service quality. These are not necessary for the basic operation, but they can be done within the framework of the proposed functionalities and improve the solution. If service quality or radio conditions are low, the probability to select these cells as target cell is decreased.

In case of per cell radio parameters, the probability or ratio of the bad values of the target cells may be considered, like P(RSRP<−115 dBm) are considered, which can cause service quality degradation.

The radio quality parameters may also be checked in handover situations per neighbor cell relations because radio can be degraded during handover at the edge of the cell with higher probability than within the (center or center region of the) cell.

Service quality can be estimated based on historical data, in some examples based on the service quality of the same services of other subscribers in the same cell, and/or service quality of the same subscribers previously in the same cell, and/or in the same hour on previous days.

In real-time analytics during operation, per UE records may be collected by the analytics system in real-time. These records may include one more of the following parameters: Subscriber ID (identifying the subscribers), time, serving satellite/base station, and actual services used. The records may, in some examples, be updated periodically to reflect a possible change in service usage and/or serving cell.

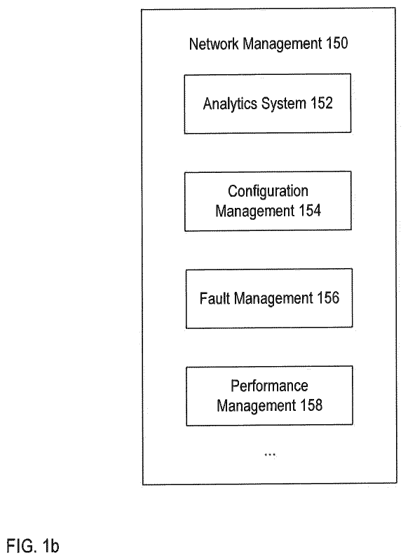

FIG. 2 shows a schematic illustration of a network management analytics system 152 according to example implementations of the present disclosure.

In this example, the network management analytics system 152 comprises a CHO optimization module 204. In this example, the CHO optimization module 204 comprises a mobility prediction 206 module and a CHO decision 208 module.

In this example, as an input, the CHO optimization module 204 receives historical and real-time analytics data as described above. In this example, handover sensitive services 210 are indicated to the CHO optimization module 204.

Data 212 relating to the timestamp, user ID, service usage, service quality and location is provided, in this example, to the service quality statistics 214 module. The service quality statistics 214 module provides per-cell service quality statistics 218 to the CHO optimization module 204. Furthermore, real-time per-subscriber correlated data 216 is provided to the CHO optimization module 204.

When a user equipment enters a new cell and starts a new session, in this example, the gNB 220 sends a request for a CHO decision to the handover module. This request includes, in this example, the user-id and the location information 226 (in some examples, the cell ID and, if available, the GPS coordinates). This request may be sent periodically, for example every 5 or 10 minutes, in order to update CHO states if a service modification or mobility trigger has not been received.

The CHO optimization module 204 fetches, in this example, the neighbor cells of the actual serving cell. A list of possible cells with the predicted probability for the user equipment to be located in the respective cell is provided via the mobility prediction model. It is checked whether CHO is beneficial for the given service and neighbor cell relation or not. In this example, based on threshold values or another configurable logic, the CHO decision 208 module provides a list of the neighbor cells which should be configured for CHO.

In some examples, the decision-making may be as follows:

```
(config parameters, example values):
x=0.3
Receive list of possible next cells with probabilities from Mobility Prediction
For each next cell
{
  If (HO probability >x AND CHO is beneficial for actual service in relation to the
next cell)
    Then: Add next cell to CHO list
}
Send CHO list in Request
Whether CHO is beneficial for actual service in relation to the next cell decided based
on the following evaluation:
If
(
Handover failure ratio for neighbor cell relations < 0.1 AND
Handover failure ratio for CHO < Handover failure ratio for non-CHO AND
Is service HO sensitive AND
Probability for service quality degradation during handover for the neighbor cell for
the actual service for CHO < Probability for service quality degradation during
handover for the neighbor cell for the actual service for non-CHO AND
P(RSRP < − 115 dBm)< 0,05 (optional) AND
P(RSRQ < − 15 dB)< 0.05 (optional) AND
Service quality in next cell > 3.5 (optional)
)
Then: CHO is beneficial for actual service in relation to the next cell
```

The request may be sent to each affected gNB.

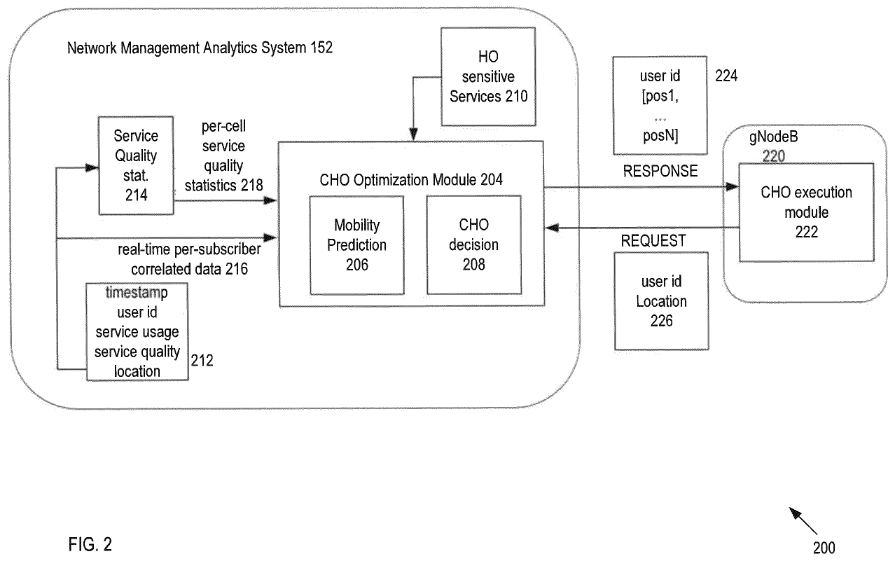

When the response message (including data 224 regarding the user-id and position 1 to position N) is received, the CHO execution module 222 configures CHO for the requested cells. This process is shown in FIG. 3, which depicts a flow diagram 300 of service quality statistics collection according to example implementations of the present disclosure.

As can be seen, data 212 comprising timestamp, user ID, service usage, service quality and location of the user equipment is obtained to generate real-time per-subscriber correlated data provided to perform service statistics collection 302. The data obtained via service statistics collection 302 is then provided to a service quality statistics database 304.

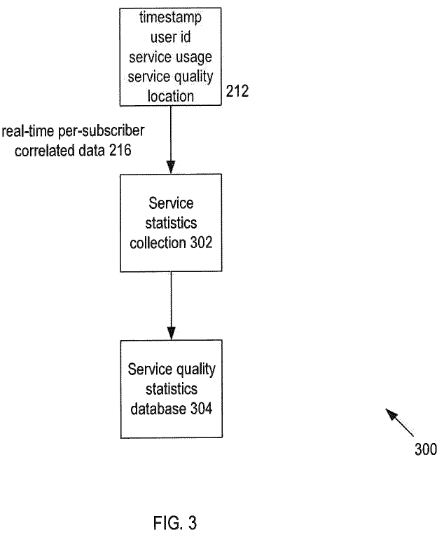

FIG. 4 shows a flow diagram 400 of mobility prediction model training according to example implementations of the present disclosure.

In this example, data 212 comprising timestamp, user ID, service usage, service quality and location of the user equipment is obtained to generate real-time per-subscriber correlated data provided to perform mobility model training 402. The data obtained via mobility model training 402 is then provided to generate the mobility prediction model 404.

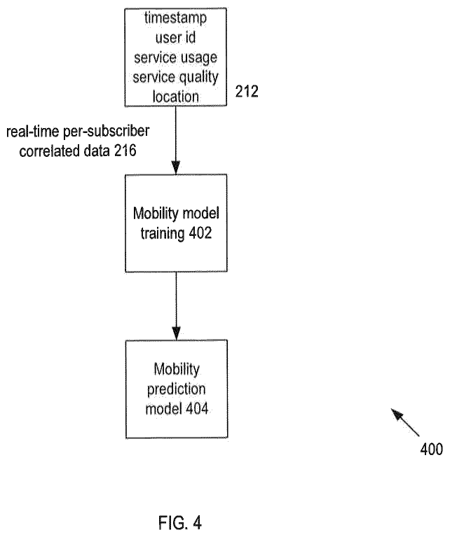

FIG. 5 shows a flow chart 500 of conditional handover optimization according to example implementations of the present disclosure.

In this example, data 212 comprising timestamp, user ID, service usage, service quality and location of the user equipment is obtained to generate real-time per-subscriber correlated data 216 provided as an input to perform different steps. In this example, this data together with per-cell service quality statistics 218 obtained from service quality statistics database 304 are provided to determine, at step S502, whether CHO is needed at all. If this is the case, mobility prediction is performed at step S504. From the mobility prediction, real-time per-subscriber correlated data 216 is provided to obtain the mobility prediction model 404, which provides one or more predicted locations 502 to the mobility prediction module. Based on the mobility prediction, CHO settings are output in order to optimize, at step S506, CHO.

If it is determined at step S502 that no CHO is needed, the method stops at step S508.

As will be appreciated, the mobility prediction model may be generated and trained as outlined above in relation to FIG. 4. Furthermore, the service quality statistics database 304 is obtained as outlined above in relation to FIG. 3.

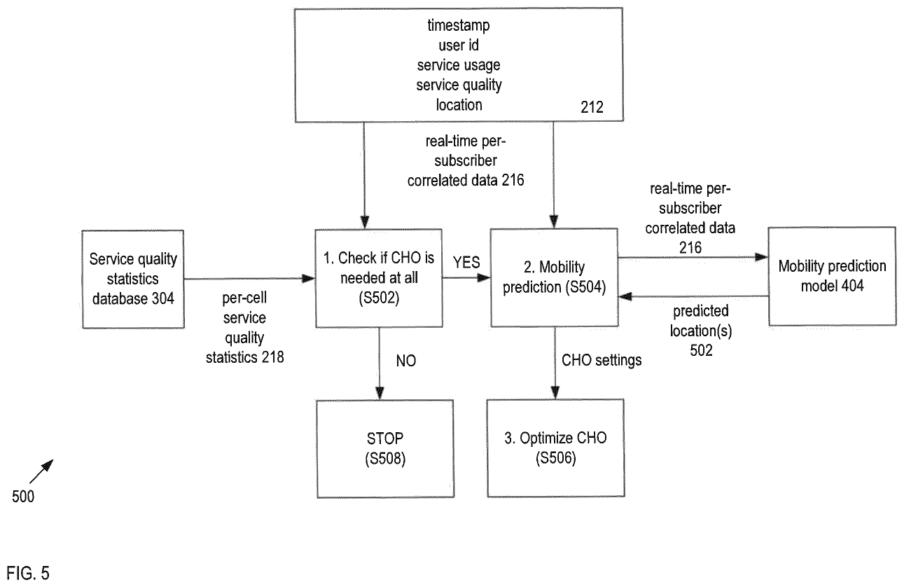

FIG. 6 shows a schematic block diagram of an apparatus 600 according to example implementations of the present disclosure.

In this example, the apparatus 600 comprises a processor 602 coupled to a memory 604. Data may be obtained by the apparatus 600 via the input interface 606 and processed by processor 602 based on program code portions which may be stored in memory 604. The processed data may be output via the output interface 608.

The apparatus 600 may be adapted to operate in the wireless communication network for at least partially controlling a conditional handover for a user equipment. The apparatus is configured to predict, based on a known first location of the user equipment in a first cell of the wireless communication network at a first point in time, a second location of the user equipment at a second point in time by applying a movement prediction to the user equipment relative to the known first location at the first point in time to obtain a probability for the second location to be located in the first cell and/or in any one of one or more second cells in the wireless communication network. The one or more second cells are different from the first cell. The apparatus may further be configured to determine, based on the obtained probability, for which one or more of the one or more second cells the conditional handover is to be configured.

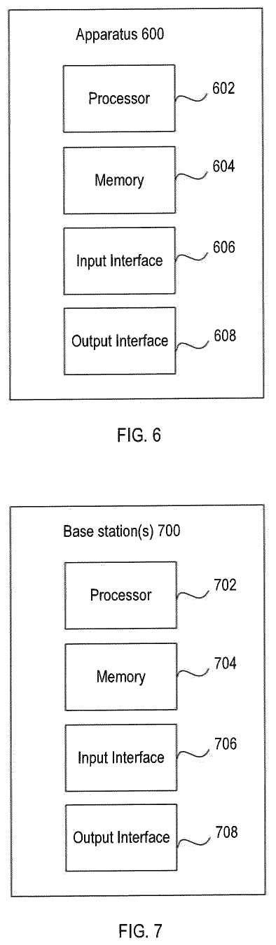

FIG. 7 shows a schematic block diagram of any one or more of the base stations 700 (or generally node) according to example implementations of the present disclosure.

In this example, the base station 700 comprises a processor 702 coupled to a memory 704. Data may be obtained by the base station 700 via the input interface 706 and processed by processor 702 based on program code portions which may be stored in memory 704. The processed data may be output via the output interface 708.

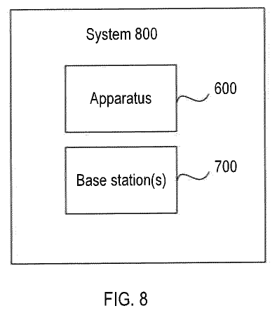

FIG. 8 shows a schematic block diagram of a system 800 according to example implementations of the present disclosure. The system 800 comprises the apparatus 600 and one or more base stations 700.

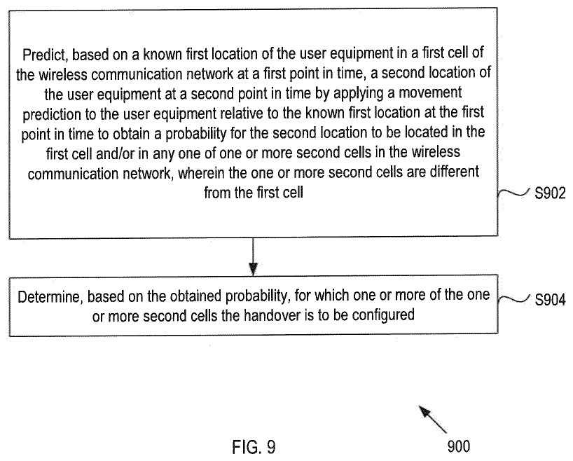

FIG. 9 shows a flow diagram of a method 900 according to example implementations of the present disclosure.

The method 900 comprises, at step S902, predicting, based on a known first location of the user equipment in a first cell of the wireless communication network at a first point in time, a second location of the user equipment at a second point in time by applying a movement prediction to the user equipment relative to the known first location at the first point in time to obtain a probability for the second location to be located in the first cell and/or in any one of one or more second cells in the wireless communication network. The one or more second cells are different from the first cell. At step 904, the method 900 comprises determining, based on the obtained probability, for which one or more of the one or more second cells the conditional handover is to be configured.

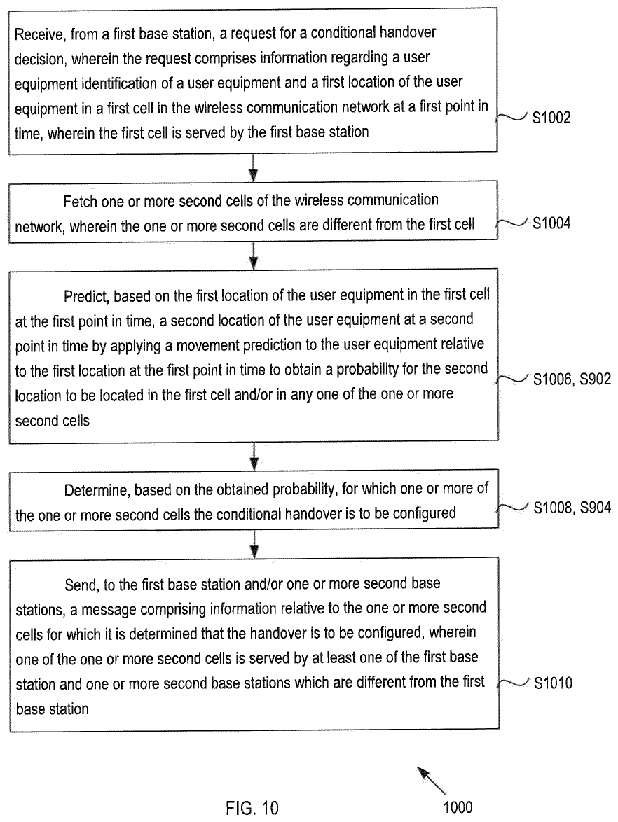

FIG. 10 shows a flow diagram of a further method 1000 performed by a network management analytics module or apparatus in a wireless communication network according to example implementations of the present disclosure.

The method 1000 comprises, at step S1002, receiving, from a first base station, a request for a conditional handover decision. The request comprises information regarding a user equipment identification of a user equipment and a first location of the user equipment in a first cell in the wireless communication network at a first point in time, wherein the first cell is served by the first base station.

At step S1004, one or more second cells of the wireless communication network are fetched, wherein the one or more second cells are different from the first cell.

At step S1006 (which may be step S902 shown in FIG. 9), based on the first location of the user equipment in the first cell at the first point in time, a second location of the user equipment at a second point in time is predicted by applying a movement prediction to the user equipment relative to the first location at the first point in time. This allows obtaining a probability for the second location to be located in the first cell and/or in any one of the one or more second cells.

At step S1008 (which may be step S904 shown in FIG. 9), based on the obtained probability, it is determined for which one or more of the one or more second cells the conditional handover is to be configured.

At step S1010, a message is sent to the first base station and/or one or more second base stations, wherein the message comprises information relative to the one or more second cells for which it is determined that the conditional handover is to be configured. One of the one or more second cells is served by at least one of the first base station and one or more second base stations which are different from the first base station.

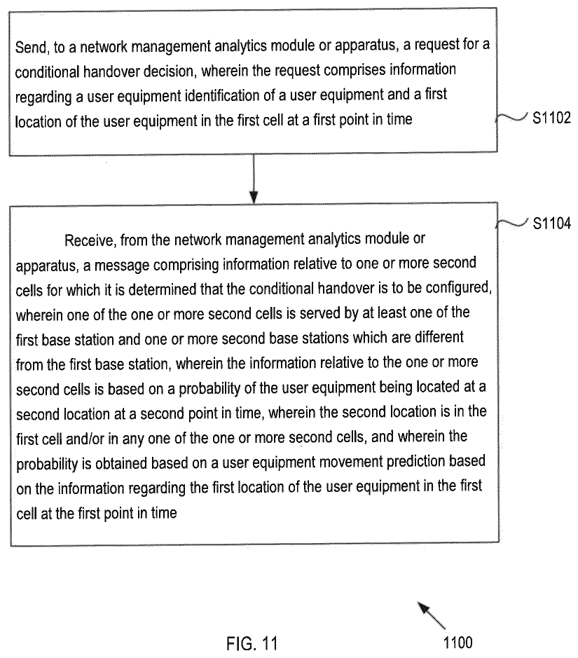

FIG. 11 shows a flow diagram of a further method 1100 performed by a first base station serving a first cell in a wireless communication network according to example implementations of the present disclosure.

At step S1102, a request for a conditional handover decision is sent to a network management analytics module or apparatus. The request comprises information regarding a user equipment identification of a user equipment and a first location of the user equipment in the first cell at a first point in time.

At step S1104, the method 1100 comprises receiving, from the network management analytics module or apparatus, a message comprising information relative to one or more second cells for which it is determined that the conditional handover is to be configured. One of the one or more second cells is served by at least one of the first base station and one or more second base stations which are different from the first base station. The information relative to the one or more second cells is based on a probability of the user equipment being located at a second location at a second point in time. The second location is in the first cell and/or in any one of the one or more second cells. The probability is obtained based on a user equipment movement prediction based on the information regarding the first location of the user equipment in the first cell at the first point in time.

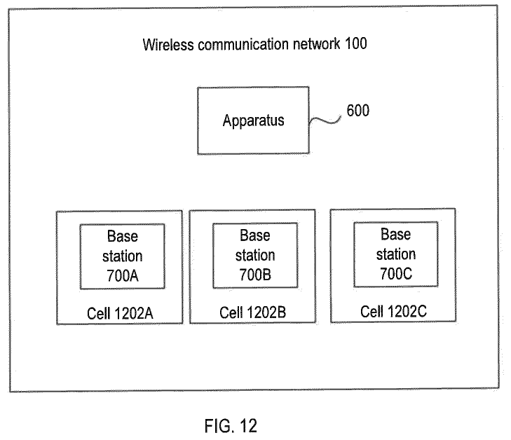

FIG. 12 shows a schematic block diagram of a wireless communication network 100 according to example implementations of the present disclosure.

In this example, the wireless communication network 100 comprises the apparatus 600, as well as base stations 700A-C. Base station 700A serves cell 1202A. Base station 700B serves cell 1202B. Base station 700C serves cell 1202C, whereby the user equipment may experience a (conditional) handover from, e.g., cell 1202A to either 1202B or 1202C. Whether one or both of cells 1202B and 1202C may be configured for conditional handover may be determined according to example implementations of the present disclosure. As will be appreciated, a base station (for example base station 700A) may serve to or more cells (for example, cells 1202A-C), and the user equipment may experience a handover from, e.g., cell 1202A to either 1202B or 1202C.

Example implementations according to the present disclosure allow for certain advantages and benefits. For example, if a user equipment moves from cell A (actual serving cell) to cell B (target cell), the user equipment may use a real-time handover sensitive traffic. Without the CHO feature, the user equipment may be handed over to cell B with a legacy (for example X2 or S1) handover process. While signaling is moderate, the relatively long handover execution time may affect the service and a short service degradation may be detected by the subscriber.

If a standard CHO is used, all the neighbors cells are configured for the CHO so that no service quality degradation is experienced. However, CHO may considerably increase the signaling at the network level.

If the CHO according to examples of the present disclosure is implemented, only cell B and, for example, one further cell C are configured for the CHO. The benefit may be that no service quality degradation is experienced by the user equipment and the CHO signaling load may be kept to a minimum, so that a moderate load is experienced at the network level. The CHO signaling load may hereby be decreased by, for example, 60 to 90%.

Furthermore, it may be possible that cell B has a coverage hole and later on the user equipment may experience service quality degradation due to this coverage hole (and not necessarily a degradation due to the handover). When the optional radio quality conditions are taken into consideration, it may be indicated that, for example, Reference Signal Received Power (RSRP) is low for cell B cell and cell C is selected for the next cell instead of cell B. The handover to cell B is thus avoided and the user equipment is handed over to cell C by the CHO.

The advantages appear in particular at the network level and it can be monitored, demonstrated by dashboards, showing the service quality with and without CHO for HO sensitive and for HO non-sensitive services, the signaling load using or not using CHO, and showing details of sessions subject to CHO and non-CHO, showing, e.g., service quality with fine time granularity in relation to the handover procedures and radio conditions.

According to examples of the present disclosure, the mobile network analytics system may be extended with a mobility prediction module that can predict the next possible location(s) for each active subscriber in the network. The conditional handover feature introduced in the (e.g. 5G) network may be optimized with a new conditional handover optimization module. The conditional handover optimization module may utilize the new mobility prediction module in order not to prepare all neighbors of the current cell for each user but only those ones which are the ones where the user will (likely) move. CHO activation may be limited to handover sensitive services, reducing the signaling load. Service quality statistics collection as a new module may also provide input to the conditional handover optimization module on what services require the activation of the conditional handover feature in relation to the neighbor cell. Furthermore, by conditional handover optimization the radio conditions and the expected service quality in the target cell may be estimated, which may be taken into account in the HO decision, improving overall service quality.

In some examples outlined herein, the handover is configured in advance (of the handover) in case of conditional handover, but not in case of (regular/normal/legacy) handover. This may make handover fast, but it may require more resources, so that the number of cells configured for the handover in advance of the handover may be limited, where this configuration is performed. Handover to other neighbor cells may, in some examples, still be possible with regular handover (for example if it is needed, but the probability therefor may be low).

It will be appreciated that the present disclosure has been described with reference to exemplary embodiments that may be varied in many aspects. As such, the present invention is only limited by the claims that follow.

1-31. (canceled)

32. A method for use in a conditional handover for a user equipment in a wireless communication network, wherein the method comprises:
predicting, based on a known first location of the user equipment in a first cell of the wireless communication network at a first point in time, a second location of the user equipment at a second point in time by applying a movement prediction to the user equipment relative to the known first location at the first point in time to obtain a probability for the second location to be located in at least one of the first cell and any one of one or more second cells in the wireless communication network, wherein the one or more second cells are different from the first cell; and
determining, based on the obtained probability, for which one or more of the one or more second cells the conditional handover is to be configured.

33. The method of claim 32, wherein said applying of the movement prediction to the user equipment to obtain the probability is based at least in part on one or both of:
a speed of movement of the user equipment; and
a direction of movement of the user equipment.

34. The method of claim 32, further comprising determining whether there is a difference in service quality between the conditional handover and a non-conditional handover, wherein the conditional handover comprises configuring a plurality of the second cells for the conditional handover and wherein the non-conditional handover comprises configuring a single one of the second cells for the non-conditional handover.

35. The method of claim 34, wherein:
if there is a difference in service quality, a predefined number of the second cells is configured for the conditional handover, wherein the predefined number of the second cells is less than a total number of cells neighboring the first cell; and
if there is no difference in service quality, only the single one of the second cells is configured for the non-conditional handover.

36. The method of claim 32, wherein the conditional handover is configured for two of the second cells with two highest probabilities for the second location to be located in the respective one of the two cells amongst the second cells.

37. The method of claim 32, wherein the conditional handover is configured only for those of the second cells for which the probability is above a predefined threshold probability.

38. The method of claim 34, wherein the conditional handover is configured for one or more of the second cells only when a service used by the user equipment at the first point in time is predefined to be a handover-sensitive service comprising one or more of ultra-low latency traffic, real-time video, and voice service.

39. The method of claim 34, wherein the non-conditional handover is configured when a service used by the user equipment at the first point in time is predefined to be a handover-non-sensitive service comprising one or both of a data file download and web browsing.

40. The method of claim 32, wherein the applying of the movement prediction comprises applying a movement prediction model to the user equipment, and wherein the method further comprises:
training the movement prediction model based on a user identity relative to the user equipment, a first timestamp (T1), a first position of the user equipment at the first timestamp T1, a second timestamp (T2), and a second position of the user equipment at the second timestamp T2; and
wherein said training of the movement prediction model is further based on information relative to a service used by the user equipment at T1.

41. The method of claim 40, further comprising determining an accuracy of the movement prediction model by comparing a predicted position of the user equipment at the second timestamp T2 with the second position, wherein the predicted position of the user equipment at the second timestamp T2 is based on applying the movement prediction model to the user equipment being at the first position at T1.

42. The method of claim 40, wherein the second location is predicted after:
the training has been performed for at least a predefined time period; and/or
an amount of input feature samples for the training is above a predefined threshold amount.

43. The method of claim 41, wherein the second location is predicted after the accuracy is above a predefined threshold accuracy.

44. The method of claim 40, used in the conditional handover for a plurality of user equipments, wherein the training is performed for no more than a fraction n % of the plurality of user equipments simultaneously, wherein n<100, and wherein the training is repeated 100/n times to cover each of the plurality of user equipments, and wherein the user equipments of the fraction n % are randomly chosen for each training performance.

45. The method of claim 32, wherein a frequency for the determining for which of the one or more second cells the conditional handover is to be configured is dependent on a moving speed of the user equipment.

46. The method of claim 32, wherein the second location is predicted continuously, and wherein the determining for which of the one or more second cells the conditional handover is to be configured is performed at one or more predefined times in a time window starting with the first point in time and ending with the second point in time.

47. The method of claim 32, wherein a number of cells for which the probability is predicted is chosen so that a summed probability for the second location to be located in any one of the number of cells is higher than a predefined probability threshold of 90%.

48. The method of claim 32, further comprising configuring the conditional handover for those one or more cells of the one or more second cells which neighbor the first cell.

49. The method of claim 32, wherein the determining for which of the one or more second cells the conditional handover is to be configured is further based on one or more of:
a neighbor cell relation between the first cell and a corresponding, respective one of the one or more second cells;
a handover success rate and/or handover failure rate for the neighbor cell relation;
a service quality degradation during handover for the neighbor cell relation and/or for one or more service types;
a service quality per cell and/or per the neighbor cell relation and/or per service; and
a radio condition per cell and/or per the neighbor cell relation.

50. An apparatus adapted to operate in a wireless communication network for at least partially controlling a conditional handover for a user equipment, wherein the apparatus is configured to:
predict, based on a known first location of the user equipment in a first cell of the wireless communication network at a first point in time, a second location of the user equipment at a second point in time by applying a movement prediction to the user equipment relative to the known first location at the first point in time to obtain a probability for the second location to be located in at least one of the first cell and any one of one or more second cells in the wireless communication network, wherein the one or more second cells are different from the first cell; and
determine, based on the obtained probability, for which one or more of the one or more second cells the conditional handover is to be configured.

51. A non-transitory computer readable medium having a computer program product stored thereon, the computer program product comprising program code portions that, when executed on processing circuitry of an apparatus configured to at least partially control a conditional handover for a user equipment, configures the processing circuitry to:
predict, based on a known first location of the user equipment in a first cell of the wireless communication network at a first point in time, a second location of the user equipment at a second point in time by applying a movement prediction to the user equipment relative to the known first location at the first point in time to obtain a probability for the second location to be located in at least one of the first cell and any one of one or more second cells in the wireless communication network, wherein the one or more second cells are different from the first cell; and
determine, based on the obtained probability, for which one or more of the one or more second cells the conditional handover is to be configured.
